(19) United States
(12) Patent Application Publication
(10) Pub. No.: US 2025/0210255 A1
(43) Pub. Date: Jun. 26, 2025

(54) ELECTRONIC COMPONENT, CAPACITOR, AND LAMINATE

(71) Applicant: Panasonic Intellectual Property Management Co., Ltd., Osaka (JP)

(72) Inventors: Takayuki HATTORI, Osaka (JP); Yukihiro SHIMASAKI, Hyogo (JP); Hiroki TAKEOKA, Nara (JP)

(21) Appl. No.: 18/847,554

(22) PCT Filed: Mar. 9, 2023
(86) PCT No.: PCT/JP2023/009042

§ 371 Date: Sep. 16, 2024

(30) Foreign Application Priority Data
Mar. 18, 2022 (JP) 2022-044710

(51) Int. Cl. H01G 2/10

(52) U.S. Cl. CPC H01G 2/10

(57) ABSTRACT

An electronic component includes an electronic component element and a barrier layer disposed outside the electronic component element. The barrier layer includes a clay layer containing clay and a water absorbing layer containing a water absorbing material. The water absorbing layer is disposed between the electronic component element and the clay layer. The clay layer preferably further contains a binder. The clay contains mineral particles preferably including a plate-shaped or thin-flake-shaped particle.

### TECHNICAL FIELD

The present disclosure relates to electronic components, capacitors, and laminates. More specifically, the present disclosure relates to: an electronic component including an electronic component element and a barrier layer; a capacitor; and a laminate applicable to the barrier layer.

### BACKGROUND ART

Patent Literature 1 describes a case mold type capacitor. The case mold type capacitor includes: a capacitor element including a first electrode and a second electrode; a pair of terminals respectively connected to the first electrode and the second electrode of the capacitor element; and a mold resin in which the capacitor element is embedded such that parts of the terminals are exposed. The mold resin includes: an epoxy resin including an inorganic filler; and a molecular sieve mixed with the epoxy resin and having a micropore diameter of greater than or equal to 3.7 Å and less than or equal to 4.3 Å. An addition amount of the molecular sieve is greater than or equal to 5 parts by weight and less than or equal to 6 parts by weight with respect to 100 parts by weight of the epoxy resin including the inorganic filler.

Since the above-described case mold type capacitor includes the mold resin with which the molecular sieve, which is a hygroscopic agent, has been mixed, the case mold type capacitor holds moisture coming in from outside by the hygroscopic agent, can delay the moisture from reaching the capacitor element, and thus has improved moisture resistance.

For such an electronic component as the capacitor described in Patent Literature 1, a further improvement in moisture resistance is desirable. In particular, an electronic component is desirable whose performance is less likely to be degraded and which has excellent moisture resistance even in a use situation where the electronic component is exposed to moisture for a long time period.

### CITATION LIST

### Patent Literature

Patent Literature 1: JP 4973735 B2

### SUMMARY OF INVENTION

It is an object of the present disclosure to provide an electronic component and a capacitor which have excellent moisture resistance.

Another object of the present disclosure is to provide a laminate applicable to the electronic component, the capacitor, and the like which have excellent moisture resistance.

An electronic component according to an aspect of the present disclosure includes: an electronic component element; and a barrier layer disposed outside the electronic component element. The barrier layer includes a clay layer containing clay and a water absorbing layer containing a water absorbing material. The water absorbing layer is disposed between the electronic component element and the clay layer.

A capacitor according to an aspect of the present disclosure is the electronic component, wherein the electronic component element of the electronic component is a capacitor element.

A laminate according to an aspect of the present disclosure includes: at least one clay layer containing clay which suppresses passage of moisture; and at least one water absorbing layer containing a water absorbing material such that the moisture passing through the at least one clay layer is absorbed by the water absorbing material.

### BRIEF DESCRIPTION OF DRAWINGS

FIG. 1 is a conceptual view of an electronic component (capacitor) according to the present embodiment;

FIG. 2 is a conceptual view of another electronic component (capacitor) according to the present embodiment;

FIGS. 3A and 3B are each a conceptual view schematically illustrating a laminate according to the present embodiment;

FIGS. 4A, 4B, and 4C are each a conceptual view of another laminate according to the present embodiment;

FIGS. 5A and 5B are each a conceptual view of another laminate according to the present embodiment;

FIGS. 6A and 6B are each a conceptual view of another laminate according to the present embodiment;

FIGS. 7A and 7B are each a conceptual view of another laminate according to the present embodiment;

FIGS. 8A and 8B are each a conceptual view of another laminate according to the present embodiment;

FIGS. 9A, 9B, and 9C are each a conceptual view of another laminate according to the present embodiment;

FIGS. 10A, 10B, and FIG. 10C are each a conceptual view of another laminate according to the present embodiment;

FIG. 11A is a conceptual view of the electronic component before a high temperature high humidity test;

FIG. 11B is a conceptual view of the electronic component after the high temperature high humidity test;

FIG. 12 is a conceptual view of an electronic component (capacitor) according to the present embodiment;

FIGS. 13A, 13B, and 13C are each a conceptual view of another electronic component (capacitor) according to the present embodiment;

FIG. 14A is a conceptual view of a mineral particle; and

FIG. 14B is a conceptual view of a clay layer.

### DESCRIPTION OF EMBODIMENTS

### First Embodiment

### (1) Overview

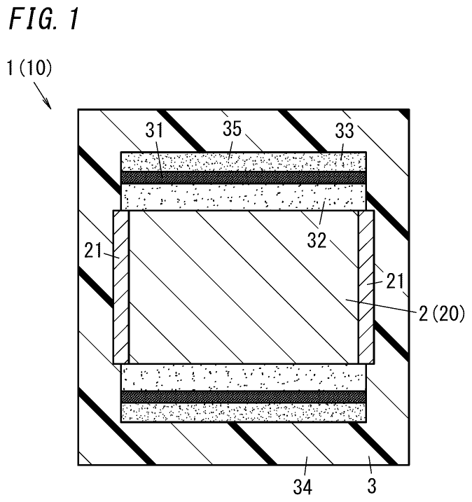

An electronic component 1 according to the present embodiment includes an electronic component element 2 and a barrier layer 3 disposed outside the electronic component element 2 (see FIG. 1). The barrier layer 3 includes a clay layer 31 containing clay and a water absorbing layer 32 containing a water absorbing material. The water absorbing layer 32 is disposed between the electronic component element 2 and the clay layer 31.

In the electronic component 1 of the present embodiment, the barrier layer 3 enables moisture to be suppressed from externally reaching the electronic component element 2, and therefore, a change in performance due to moisture absorption is small, and the electronic component 1 of the present embodiment thus has high moisture resistance. That is, in the electronic component 1 of the present embodiment, the barrier layer 3 disposed outside the electronic component element 2 includes the clay layer 31 less permeable to moisture than a layer of the same thickness but consisting of a resin. Moreover, the clay layer 31 has a labyrinthine structure and thus allows less moisture and gas to pass therethrough per unit thickness and per unit time than the layer of the same thickness but consisting of the resin. Thus, the barrier layer 3 including the clay layer 31 readily reduces passage of the moisture and the gas as compared with a resin layer of the same thickness and including no clay layer 31 and consisting of a resin. As a result, the electronic component 1 of the present embodiment is readily downsized by reducing the thickness of the barrier layer 3 while the barrier layer 3 ensures moisture resistance.

Moreover, since the barrier layer 3 of the electronic component 1 of the present embodiment includes the water absorbing layer 32, moisture can be absorbed by the water absorbing layer 32, thereby highly effectively suppressing the moisture from reaching the electronic component element 2. That is, moisture has to pass through the water absorbing layer 32 to reach the electronic component element 2 from outside the barrier layer 3, but the moisture entering the water absorbing layer 32 is absorbed by the water absorbing material in the water absorbing layer 32, and thus, the chance that the moisture passes through the water absorbing layer 32 is reduced. Thus, the chance that the moisture reaches the electronic component element 2 is reduced, and the moisture resistance of the electronic component 1 is suppressed from degrading.

Moreover, in the electronic component 1 of the present embodiment, the water absorbing layer 32 is disposed between the electronic component element 2 and the clay layer 31, and therefore, moisture passing through the clay layer 31 is to be absorbed by the water absorbing layer 32. The clay layer 31 has the labyrinthine structure and thus allows less moisture and gas to pass therethrough per unit thickness and per unit time than the layer of the same thickness but consisting of the resin. Thus, as compared with the case without the clay layer 31, the amount of moisture reaching the water absorbing layer 32 can be reduced, and the moisture absorbed by the water absorbing material is thus reduced. As a result, a timing at which the water absorption characteristic of the water absorbing material saturates can be delayed, and the water absorption of the water absorbing layer 32 can be suppressed from decreasing. Therefore, even when the electronic component 1 of the present embodiment is used in an environment in which the electronic component 1 is exposed to a large amount of moisture for a long time period, the moisture resistance is less likely to be degraded.

### (2) Details

### <Electronic Component>

As shown in FIG. 1, the electronic component 1 according to the present embodiment includes the electronic component element 2 and the barrier layer 3 covering the electronic component element 2. The electronic component element 2 is a component or a portion for causing the electronic component 1 to exhibit an intended function. The barrier layer 3 has a function of protecting the electronic component element 2. For example, the barrier layer 3 has a function of protecting the electronic component element 2 from moisture. Further, the barrier layer 3 may have a function of protecting the electronic component element 2 from gas, heat, light, electromagnetic waves, impact, chemicals, and the like. That is, the electronic component element 2 is protected by being almost entirely covered with the barrier layer 3. Note that in the electronic component 1 of the present embodiment, an external connection terminal (omitted in the figure) electrically connected to the electronic component element 2 may be led out of the barrier layer 3. In this case, the barrier layer 3 is formed to cover the entirety of the electronic component element 2 except for the external connection terminal.

### <Electronic Component Element>

An example in which the electronic component 1 is a capacitor 10 will be described below. The electronic component 1 which is the capacitor 10 includes a capacitor element 20 as the electronic component element 2. That is, the electronic component element 2 of the capacitor 10 is the capacitor element 20.

As the capacitor element 20, various types of capacitor elements may be used depending on the type of the capacitor 10. In the present embodiment, the capacitor 10 is, for example, a film capacitor, a ceramic capacitor, an electrolytic capacitor, or the like. Among them, the capacitor 10 is preferably the film capacitor. The film capacitor is formed from a metalized film including a dielectric film and an electrode film on the dielectric film. The electrode film is, in many cases, made of Al, Zn, Mg, Cu, Ag, or an alloy thereof, and in particular, an electrode film including Al as a main component is widely used. Moreover, of film capacitors, a film capacitor including a wound capacitor element 20 is preferable. In this case, a pair of the metalized films are prepared, and the wound capacitor element 20 is formed by winding the pair of the metalized films a plurality of number of turns. Then, by using a device and a procedure similar to those for manufacturing the wound capacitor element 20, a laminate 35 described later can be wound around the capacitor element 20, and thereby, the capacitor element 20 with the laminate 35 wound therearound can be easily manufactured. Note that the capacitor element 20 may be a stacked film capacitor.

The capacitor element 20 includes external electrodes 21 at respective both ends in an axial direction. The external electrodes 21 are preferably formed by metallikon of a metal material. The external electrodes 21 are, in many cases, made of Al, Zn, Mg, Cu, Ag, or an alloy thereof, and in particular, external electrodes including Al as a main component are widely used.

### <Barrier Layer>

The barrier layer 3 has a function of protecting the capacitor element 20 from moisture. Further, the barrier layer 3 may have a function of protecting the capacitor element 20 from gas, heat, light, electromagnetic waves, impacts, chemicals, and the like. As shown in FIG. 1, the barrier layer 3 covers the entirety of the capacitor element 20. That is, the capacitor element 20 is encapsulated and protected by the barrier layer 3. The barrier layer 3 includes the laminate 35 and a resin layer 34.

### <Laminate>

The laminate 35 is a barrier film. That is, the laminate 35 has a function of protecting the capacitor element 20 from moisture. The laminate 35 may further have a function of protecting the capacitor element 20 from gas, heat, light, electromagnetic wave, impact, chemicals, and the like. The laminate 35 covers at least part of a peripheral part of the capacitor element 20. The peripheral part of the capacitor element 20 refers to a part of the capacitor element 20 around an axis provided that the axis is a direction in which the pair of external electrodes 21 face each other. When the capacitor element 20 is substantially circularly columnar or substantially elliptically columnar, the laminate 35 is arranged to face a circumferential surface of the capacitor element 20. Thus, the laminate 35 covers the entirety of the capacitor element 20 except for parts where the external electrodes 21 are disposed. That is, the capacitor element 20 is almost entirely covered with the laminate 35 except for the parts where the external electrodes 21 are disposed. Thus, moisture hardly enters the capacitor element 20 from the entire peripheral part, thereby improving the moisture resistance of the capacitor 10. In particular, the circumferential surface (surface around the axis) has a larger area than the end surface (surface in the axial direction) of the capacitor element 20 in many cases, and therefore, the laminate 35 is preferably disposed to surround at least the circumferential surface of the capacitor element 20. As explained above, the laminate 35 is disposed to cover at least part of the peripheral part of the capacitor element 20. As used herein, “at least part” preferably means, for example, greater than or equal to 80% of the surface area of the outer surface of the capacitor element 20 except for the external electrodes 21.

The laminate 35 includes the clay layer 31, the water absorbing layer 32, and a base material layer 33.

### <Clay Layer>

The clay layer 31 is a layer that suppresses, for example, moisture or gas from passing through the laminate 35 in a thickness direction defined with respect to the laminate 35. That is, the laminate 35 including the clay layer 31 reduces the amount of, for example, moisture or gas passing therethrough in the thickness direction per unit time as compared with the case without the clay layer 31.

The clay layer 31 includes clay and has a layer shape. In the present disclosure, the clay is an aggregate of a plurality of mineral particles 311. The clay may include a small amount of water in the aggregate of the plurality of mineral particles 311. The mineral particles 311 include at least one type of mineral selected from the group consisting of mica, vermiculite, montmorillonite, iron montmorillonite, beidellite, saponite, Hectorite, stevensite, and nontronite. Among them, the montmorillonite, which is a high moisture-resistant clay material, is preferably included in the mineral particles 311.

In the crystal structure of montmorillonite, a unit crystal including tetrahedral structures and an octahedral structure sandwiched between the tetrahedral structures is defined as a unit layer, where the octahedral structure includes Al (aluminum atom) at its center, and the tetrahedral structures each include Si (silicon atom) at its center. Specifically, some of trivalent Al are substituted with bivalent Mg or Fe, and the unit layer is thus negative charged. Therefore, for electric charge compensation, a cationic hydrate, such as Na⁺ or Ca²⁺, is present in the crystal structure. When the montmorillonite is dispersed in water, hydration of a cationic portion of the montmorillonite advances, and the montmorillonite is likely to be separated in the unit of unit layers. Thus, the montmorillonite is dispersed in water, and thereby, the montmorillonite is easily separated into unit layers. Thus, the montmorillonite is easily contained in the clay layer 31 in a state where the montmorillonite is separated into the unit layers, and a labyrinthine structure including the mineral particles 311 is easily formed in the clay layer 31.

In the montmorillonite, ion exchange of interlayer exchangeable cations with other inorganic and other organic cations is possible. Thus, imparting an affinity for an organic solvent and intercalation of various compounds between the layers are possible. Moreover, a hydroxyl group is present on an end face of a crystal of the montmorillonite, and therefore, modification by various types of silylation agents is possible. In an attempt to achieve a high moisture-resistance of the clay layer 31, the clay layer 31 is desirably hydrophobized. For example, an exchangeable cation (e.g., Na⁺) has a high affinity for water, and if the exchangeable cation is present between the layers, the exchangeable cation is likely to be disadvantageous to hydrophobizing of the clay layer 31. Therefore, substituting the exchangeable cation with Li and a proton is considered. For example, when the montmorillonite is subjected to the heat treatment, ions move to an inside, and a surface, of the crystal, and the clay layer 31 is thus easily hydrophobized.

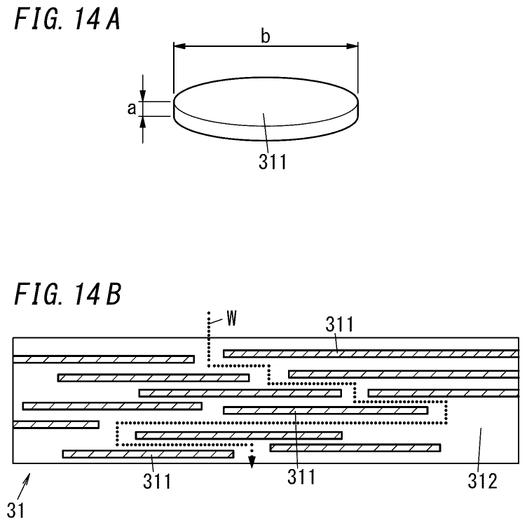

FIG. 14A shows a conceptual view of one mineral particle 311. In the present embodiment, the mineral particle 311 is a particle having a plate shape or a flake shape. That is, the mineral particle 311 is a particle shaped such that a thickness a is smaller than a lateral width b. Here, the lateral width b is a dimension at the longest part of the mineral particle 311 when the mineral particle 311 is viewed from the front (viewed from straight on in a thickness direction defined with respect to the mineral particle 311). When the mineral particle 311 has, for example, a circular disk shape, the diameter is the lateral width b. The thickness a is a dimension in a direction orthogonal to the lateral width b and is a dimension between two opposing faces of the mineral particle 311.

In the present embodiment, the mineral particle 311 has a high aspect ratio. That is, an aspect ratio defined by “lateral width b/thickness a” is high. The aspect ratio is obtained by measuring the thickness a and the lateral width b of the mineral particle 311. The thickness a is, for example, measured by using a transmission electron microscope (TEM), but the thickness of a single layer of the mineral particle 311 is substantially uniform for each type, and therefore, there is no need to measure a large amount of mineral particles 311. For example, in the case of the montmorillonite, the thickness a is about 1 nm. The lateral width b is, for example, measured by using an atomic force microscopy (AFM). A planar part of the mineral particle 311 is observed, and the longest dimension is estimated as the lateral width b.

FIG. 14B shows a conceptual view of the clay layer 31. The clay layer 31 contains the mineral particles 311 and a binder 312. That is, the clay layer 31 may include the mineral particles 311 and the binder 312 or may contain the mineral particles 311, the binder 312, and other additives. The binder 312 includes one or more types of materials selected from the group consisting of polypropylene, polyethylene, polyethylene sulfide, polyimide, polyamide, polyethylene terephthalate, an epoxy resin, a fluororesin, a polyester resin, a polyurethane resin, an acrylic resin, a phenoxy resin, polyoxymethylene, and polyvinyl alcohol. Moreover, the binder 312 may be a binder resin usable as a coating material or slurry varnish. Among them, the polypropylene, the polyethylene, the polyamide, the polyimide, the polyurethane resin, the epoxy resin, and the phenoxy resin are preferable as the binder 312 in consideration of the ease of formation of the clay layer 31 and the adhesion to the mineral particle 311 and the base material layer 33. Moreover, the resins may be subjected to modification treatment to improve the adhesion. Moreover, hardeners (cross-linking agents) suitable for the resins explained above may be used. In this case, the binder 312 is made of a cross-linked resin, and the moisture resistance of the clay layer 31 may be improved.

The clay layer 31 includes the binder 312 and the plurality of mineral particles 311 dispersed in the binder 312. The mineral particles 311 are dispersed in a state where the thickness direction defined with respect to the mineral particles 311 substantially coincides with a thickness direction defined with respect to the clay layer 31. Between the plurality of mineral particles 311 adjacent to each other in the thickness direction, a gap is provided, and the gap is filled with the binder 312. Moreover, between a plurality of mineral particles 311 adjacent to each other in a direction orthogonal to the thickness direction, a gap is also provided, and the gap is filled with the binder 312. Thus, the clay layer 31 has a structure like a labyrinth in which the gaps between the plurality of mineral particles 311 are formed as paths (labyrinthine structure). That is, in the clay layer 31, the plurality of mineral particles 311 are dispersed in a state where the plurality of mineral particles 311 are randomly located in the width direction while the thickness direction defined with respect to the plurality of mineral particles 311 coincides with the thickness direction defined with respect to the clay layer 31. Therefore, the gaps between the mineral particles 311 adjacent to each other are formed like zigzag paths. Thus, when moisture W passes through the clay layer 31 in the thickness direction, the moisture W cannot move linearly but has to move in a zig-zag manner through the gaps between the mineral particles 311 adjacent to each other (see dotted line in FIG. 14B). Thus, the clay layer 31 is less permeable to the moisture W than a resin layer (layer including only the binder) including no mineral particle, and even when the thickness of the barrier layer 3 is reduced, the moisture resistance of the capacitor 10 can be secured. For example, even when the clay layer 31 is a clay layer having a thickness of several μm to several tens of μm, a capacitor 10 having moisture resistance equivalent to a resin layer having a thickness of 2 mm and including only an epoxy resin is obtained. Thus, the capacitor 10 of the present embodiment may have moisture resistance 1000 or more times that of a barrier layer including only a resin.

The theoretical formula of the labyrinthine structure of the clay layer 31 is shown by the following formula (1).

P/P0=(1−Φ)/(1+0.5 AΦ) (1)

In the formula (1), “P/P0” is the specific permeability, Φ is the volume fraction of the mineral particles 311 in the clay layer 31, and A is the aspect ratio of the mineral particle 311.

The smaller the value of “P/P0”, the less permeable the clay layer 31 is to the moisture, and the larger the value of “P/P0”, the more permeable the clay layer 31 is to the moisture. Thus, in the formula (1), the larger the value of Φ, the more difficultly the moisture passes through the clay layer 31, and the smaller the value of Φ, the more easily the moisture passes throughs the clay layer 31. Moreover, in the formula (1), the larger the value of A, the more difficulty the moisture passes through the clay layer 31, and the smaller the value of A, the more easily the moisture passes through the clay layer 31. Thus, in order to obtain the barrier layer 3 hardly permeable to the moisture to improve the moisture resistance of the capacitor 10, the volume fraction of the mineral particles 311 in the clay layer 31 is preferably increased, and moreover, the content of the mineral particles 311 having a high aspect ratio is preferably increased.

The aspect ratio of the mineral particle 311 is preferably greater than or equal to 20. In order to obtain the clay layer 31 hardly permeable to the moisture, the mineral particles 311 having a further increased aspect ratio is preferably used, but the range described above is preferable when other performances of the clay layer 31, for example, the strength, adhesion, ease of formation, and the like of the clay layer 31, are also taken into consideration. The aspect ratio of the mineral particle 311 is more preferably greater than or equal to 100, and much more preferably greater than or equal to 150. Note that an upper limit of the aspect ratio of the mineral particle 311 is not particularly limited but is accordingly set in consideration of the dispersibility of the mineral particles 311 in the clay layer 31 and the like.

Moreover, as the mineral particles 311, high-aspect-ratio materials and low-aspect-ratio materials may be used in combination. In this case, the low-aspect-ratio materials (small-diameter mineral particles) easily enter between the high-aspect-ratio materials, thereby improving the filling factor of the mineral particles 311 in the clay layer 31. When both the high-aspect-ratio materials and the low-aspect-ratio materials are used, the high-aspect-materials preferably amount to at least half or more of the total amount of the mineral particles 311 included in the clay layer 31.

The content percentage of the mineral particles 311 in the clay layer 31 is preferably greater than or equal to 50% by mass. For example, when the clay layer 31 includes the mineral particles 311 and the binder 312, the content percentage of the mineral particles 311 is preferably greater than or equal to 50% by mass and less than or equal to 95% by mass with respect to the total amount of the clay layer 31, and the content percentage of the binder 312 is preferably greater than or equal to 5% by mass and less than or equal to 50% by mass with respect to the clay layer 31. Thus, while performances, such as the strength, adhesion, and ease of formation, of the clay layer 31 are secured, the clay layer 31 hardly permeable to moisture is easily obtained.

The thickness of the clay layer 31 is preferably greater than or equal to 0.5 μm and less than or equal to 100 μm. In order to reduce the permeation amount of moisture through the clay layer 31, the thickness of the clay layer 31 is preferably increased, but the range is preferable in consideration of performances, such as the strength, adhesion, and ease of formation, of the clay layer 31. The thickness of the clay layer 31 is more preferably greater than or equal to 0.5 μm and less than or equal to 50 μm, and much more preferably greater than or equal to 0.5 μm and less than or equal to 10 μm.

### <Water Absorbing Layer>

The water absorbing layer 32 is a layer which absorbs moisture. The water absorbing layer 32 contains a water absorbing material, and the water absorbing material adsorbs moisture. As the water absorbing material, a material, such as zeolite and a silica gel, which absorbs moisture and which does not deliquesce (liquefy) may be used. In the present embodiment, the zeolite is preferably used as the water absorbing material. The zeolite is a collective term of crystalline aluminosilicates, includes Al, Si, O, cations (positive ions) as constituent elements, and basically has tetrahedron structures each including SiO₄ or AlO₄. Then, the tetrahedron structures complexly and regularly bind together, thereby regularly forming fine pores each having a size substantially equal to a small molecule having a diameter of several Å to more than ten Å as a feature of the zeolite. Only molecules each having a diameter smaller than the diameter of the fine pores of the zeolite can enter the fine pores and can be sieved out of large molecules, and therefore, the zeolite is also referred to as a molecular sieve.

In general, the micropore diameter of the zeolite is 2 to 15 Å, but the zeolite has various types depending on micropore diameters. Specifically, there are Type 3A zeolite having a micropore diameter of 3 Å, Type 4A zeolite having a micropore diameter of 4 Å, Type 5A zeolite having a micropore diameter of 5 Å, Type 13X zeolite having a micropore diameter of 10 Å to 15 Å, and the like. In the present embodiment, an object is to adsorb moisture, and therefore, Type 3A, 4A, and 5A zeolites are preferred, and since the micropore diameters are distributed in the range of about −0.3 Å to about +0.3 Å of the representative value, zeolite having a micropore diameter of greater than or equal to 2.7 Å and less than or equal to 5.3 Å is preferably used. Note that the zeolites have crystal structures specific to respective types, and the types of the zeolites can thus be identified by X-ray diffraction (XRD).

In the present embodiment, zeolite particles preferably have such sizes that a peak (modal diameter) of particle size distribution is less than or equal to 100 μm. Using zeolite having such a small diameter facilitates formation of the water absorbing layer 32 which is a thin layer. Note that the particle size distribution of zeolite can be measured by, for example, a laser diffraction scattering method.

The water absorbing layer 32 contains a water absorbing material and a binder. That is, the water absorbing layer 32 may consist of the water absorbing material and the binder or may contain the water absorbing material, the binder, and other additives. The binder includes one or more types of materials selected from the group consisting of polypropylene, polyethylene, polyethylene sulfide, polyimide, polyamide, polyethylene terephthalate, an epoxy resin, a fluororesin, a polyester resin, a polyurethane resin, an acrylic resin, a phenoxy resin, polyoxymethylene, and polyvinyl alcohol. Moreover, the binder may be a binder resin usable as a coating material or slurry varnish. Among them, the polypropylene, the polyethylene, the polyamide, the polyimide, the polyurethane resin, the epoxy resin, and the phenoxy resin are preferable as the binder in consideration of the ease of formation of the water absorbing layer 32 and the adhesion to the water absorbing material and/or the base material layer 33. Moreover, the resins may be subjected to modification treatment to improve the adhesion. Moreover, hardeners (cross-linking agents) suitable for the resins explained above may be used. In this case, the binder is made of a cross-linked resin, and the moisture resistance of the water absorbing layer 32 may be improved.

The water absorbing layer 32 includes a plurality of absorbing materials dispersed in the binder. The content of the water absorbing material in the water absorbing layer 32 is preferably greater than or equal to 2.5 parts by mass with respect to the total amount (gross mass), 100 parts by mass, of the water absorbing layer 32. In this case, moisture entering the water absorbing layer 32 is readily absorbed by the water absorbing material, and thus, the chance that the moisture passes through the water absorbing layer 32 is reduced. The content of the water absorbing material in the water absorbing layer 32 is more preferably greater than or equal to 10 parts by mass, much more preferably greater than or equal to 30 parts by mass, with respect to the total amount, 100 parts by mass, of the water absorbing layer 32. Moreover, the content of the water absorbing material in the water absorbing layer 32 is preferably less than or equal to 90 parts by mass with respect to the total amount, 100 parts by mass, of the water absorbing layer 32. In this case, while performances, such as the strength, adhesion, and ease of formation, of the water absorbing layer 32 are secured, the water absorbing layer 32 hardly permeable to moisture is easily obtained. The content of the water absorbing material in the water absorbing layer 32 is more preferably less than or equal to 50 parts by mass with respect to the total amount, 100 parts by mass, of the water absorbing layer 32.

The thickness of the water absorbing layer 32 is preferably greater than or equal to 0.5 μm and less than or equal to 100 μm. In order to reduce the permeation amount of moisture through the water absorbing layer 32, the thickness of the water absorbing layer 32 is preferably increased, but the range is preferable in consideration of performances, such as the strength, adhesion, and ease of formation, of the water absorbing layer 32. The thickness of the water absorbing layer 32 is more preferably greater than or equal to 0.5 μm and less than or equal to 50 μm, and much more preferably greater than or equal to 0.5 μm and less than or equal to 10 μm.

Note that in the present embodiment, when the water absorbing layer 32 has a water absorption characteristic of a water absorption amount of greater than or equal to 3 mg, and preferably greater than or equal to 10 mg, the effect of improving the moisture resistance, such as the effect of suppressing a swell, can be obtained. An increased content of the water absorbing material in the water absorbing layer 32 can reduce the thickness and/or the number of stacked layers of the laminate 35 and is therefore effective. Moreover, the thickness of the resin layer 34 can also be reduced, thereby downsizing the capacitor 10. For example, a case where a laminate 35 in which the water absorbing layer 32 has a thickness of 0.001 cm is wound around a film capacitor element having a width of 5 cm and a perimeter of 20 cm is considered. In this case, when the content of the water absorbing material in the water absorbing layer 32 is 3% by mass, five layers of laminates 35 are required to achieve a water absorption amount of 3 mg, and seventeen or more layers of laminates 35 are required to achieve a water absorption amount of 10 mg. Similarly, when the content of the water absorbing material in the water absorbing layer 32 is 10% by mass, one layer of laminate 35 is required to achieve a water absorption amount of 3 mg, and four or more layers of laminates 35 are required to achieve a water absorption amount of 10 mg. Moreover, when the content of the water absorbing material in the water absorbing layer 32 is 30% by mass, one or more layers of laminates 35 are required to achieve a water absorption amount of 10 mg.

### <Base Material Layer>

The base material layer 33 is a layer which supports the clay layer 31 and the water absorbing layer 32. This improves the handleability of the clay layer 31 and the water absorbing layer 32 which are thin layers. The base material layer 33 includes a resin. Examples of a resin from which the base material layer 33 is formed include polyethylene, polypropylene, polyethylene terephthalate, polyamide, fluororesin, an acrylic resin, polyimide, polyethylene naphthalate, polymethylpentene, cyclo-olefin, polyarylate, polyether ether ketone, polyphenylene sulfide, a syndiotactic polystyrene-based resin, and an epoxy resin. The base material layer 33 includes one type, or a plurality of types, of the crystalline resin(s) listed in the examples above. The base material layer 33 preferably includes polypropylene having a good water vapor barrier property among the plurality of types of crystalline resins listed in the examples above. The water vapor barrier property refers to a property hardly permeable to water vapor. For example, a film made of polypropylene has a water vapor permeability of about 4 to 5 g/(m²·d) and has a good water vapor barrier property.

The base material layer 33 is, for example, in the shape of a film, a sheet, a plate, or the like. The thickness of the base material layer 33 is accordingly set in consideration of an electrical insulation property, flexibility, and the like and is preferably, for example, several tens of μm, and more preferably, greater than or equal to 10 μm and less than or equal to 30 μm.

The base material layer 33 is preferably a biaxially oriented polypropylene film. Thus, the water vapor barrier property is improved as compared with the base material layer 33 made of a normal polypropylene film which is not biaxially oriented.

### <Resin Layer>

The barrier layer 3 includes the resin layer 34 containing a resin. That is, the barrier layer 3 is a complex material layer including both the laminate 35 and the resin layer 34. Examples of the resin included in the resin layer 34 include an epoxy-based resin, an unsaturated polyester resin, and a polyimide resin, and when moldability and the like at the time of encapsulating the capacitor element 20 are considered, the epoxy resin is preferable. Moreover, the resin layer 34 may consist of a resin, or the resin layer 34 may be formed from a complex material including a resin and a filler. In this case, as the filler, for example, silica can be used, and the content of the filler with respect to the total amount of the resin layer 34 can be greater than or equal to 1% by mass and less than or equal to 99% by mass.

The resin layer 34 covers at least part of the capacitor element 20 and the laminate 35. The resin layer 34 preferably covers the entirety of the capacitor element 20 and the laminate 35, and in this case, the entirety of the capacitor element 20 and the laminate 35 is encapsulated by the resin layer 34. The clay layer 31 and the resin layer 34 are stacked on each other. That is, the clay layer 31 and the resin layer 34 are disposed to face each other in the thickness direction defined with respect to the laminate 35. The thickness of the resin layer 34 is preferably greater than the thickness of the clay layer 31. Thus, the clay layer 31 which has a small thickness and which easily breaks is easily protected by the resin layer 34. The thickness of the resin layer 34 is preferably greater than or equal to 1 mm and less than or equal to 6 mm. Thus, in addition to the clay layer 31, also the resin layer 34 easily reduces the moisture permeability of the clay layer 31, thereby improving the moisture resistance of the capacitor 10. The thickness of the resin layer 34 is preferably greater than or equal to 1 mm and less than or equal to 4.5 mm, and more preferably greater than or equal to 1 mm and less than or equal to 3 mm.

### <Operation of Barrier Layer>

As shown in FIG. 1, the barrier layer 3 is disposed outside the capacitor element 20 (the electronic component element 2) to surround the entirety of the capacitor element 20. That is, the capacitor element 20 is encapsulated by the barrier layer 3. Of the laminate 35 and the resin layer 34 included in the barrier layer 3, the laminate 35 is disposed to face the circumferential surface of the capacitor element 20. That is, the laminate 35 is disposed along the outer surface of the capacitor element 20 such that the laminate 35 does not cover end surfaces (surfaces aligned in the axial direction) of the external electrodes 21 of the capacitor element 20. Moreover, of the laminate 35 and the resin layer 34 included in the barrier layer 3, the resin layer 34 is disposed to surround the entirety (including the end surfaces of the external electrodes 21) of the capacitor element 20 on whose outer surface the laminate 35 has been disposed.

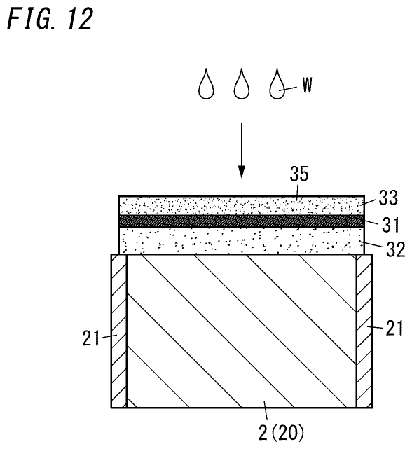

In the capacitor 10 (the electronic component 1) configured as described above, moisture has to pass through the barrier layer 3 to reach the capacitor element 20 from outside the barrier layer 3. However, the capacitor 10 of the present embodiment includes the laminate 35, and therefore, moisture difficultly reaches the capacitor element 20. First of all, moisture outside the barrier layer 3 has to pass through the resin layer 34, which reduces the chance that the moisture reaches the capacitor element 20 as compared with the case without the barrier layer 3. Further, as shown in FIG. 12, even when the moisture passing through the resin layer 34 reaches the laminate 35, the moisture has to pass through the laminate 35 in the thickness direction, which reduces the chance that the moisture reaches the capacitor element 20 as compared with the case without the laminate 35. In particular, the laminate 35 includes the clay layer 31 containing clay and is thus hardly permeable to moisture due to the labyrinthine structure of the clay layer 31. Moreover, the laminate 35 also includes the water absorbing layer 32 containing the water absorbing material, and thus, moisture is adsorbed by the water absorbing material, and the chance that the moisture passes through the laminate 35 is reduced. Thus, in the capacitor 10 of the present embodiment, the chance that the moisture reaches the capacitor element 20 is reduced, which reduces the deterioration of the capacitor element 20 due to the moisture, and the capacitor 10 thus has high moisture resistance (high reliability in moisture resistance).

Moreover, in the present embodiment, the water absorbing layer 32 is disposed between the clay layer 31 and the capacitor element 20. That is, the clay layer 31 is disposed outside the water absorbing layer 32 (on an opposite side of the water absorbing layer 32 from the capacitor element 20). Therefore, moisture entering the laminate 35 passes through the clay layer 31 at first and then enters the water absorbing layer 32. Therefore, as compared with the case without the clay layer 31, the laminate 35 of the present embodiment can reduce the amount of moisture reaching the water absorbing layer 32 per unit time. As a result, the amount of moisture absorbed by the water absorbing material of the water absorbing layer 32 decreases, and the water absorbing performance of the absorbing member is less likely to be saturated. Thus, a decrease in water absorbing performance of the water absorbing layer 32 is suppressed for a long time period, and the moisture resistance of the capacitor 10 is readily secured for a long time period.

Moreover, the present embodiment includes the water absorbing layer 32 in addition to the clay layer 31, and therefore, moisture passing through the clay layer 31 can be trapped by the water absorbing layer 32, that is, a small amount of moisture may pass through the clay layer 31 but can be kept in the laminate 35 so as not to reach the capacitor element 20.

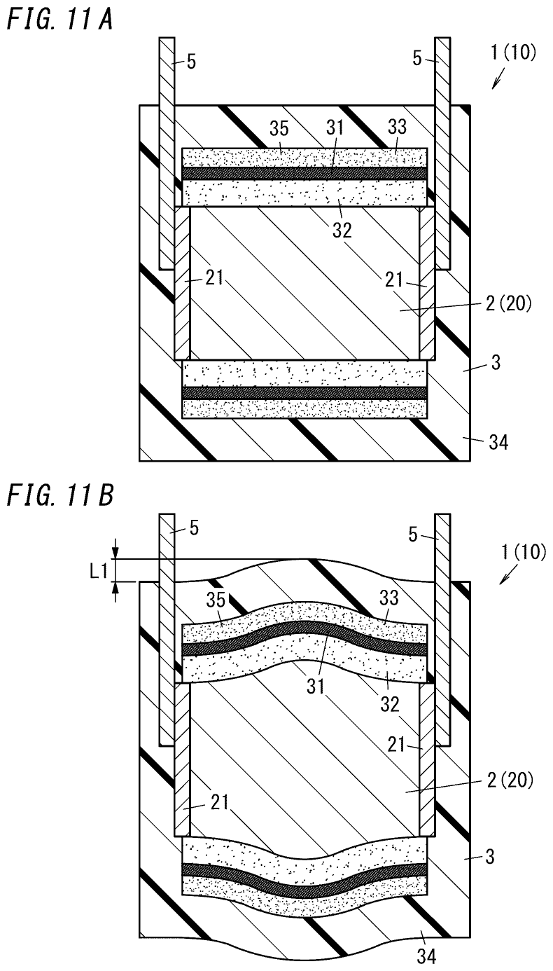

For example, a capacitor 10 having external connection terminals 5 which are electrically connected to the respective external electrodes 21 and which are led out of the barrier layer 3 is formed as shown in FIG. 11A. The capacitor 10 is then subjected to a high temperature high humidity test (85° C./85%, a voltage of 615 V is applied to the external connection terminals 5) 500 times, and thereafter, a swell L1 of the barrier layer 3 as shown in FIG. 11B is evaluated. Here, L1 in the case of the high temperature high humidity test being performed in a state where the water absorbing layer 32 includes no zeolite is defined as being 1. In this case, the high temperature high humidity test performed in a state where the water absorbing layer 32 includes zeolite results in that L1 is 0.11, that is, the swell is reduced by about 90%. Note that the base material layer 33 is formed from a polypropylene film, the clay layer 31 includes clay and a binder in a ratio of 7:3 (in terms of weight), and the water absorbing layer 32 includes a polyolefin-based resin (binder) and 30% by mass of Type A5 zeolite (powder type).

The swell as described above may be caused by the influence of moisture over the capacitor element 20. That is, when aluminum is used as an electrode film of the capacitor element 20, and zinc and/or tin is used for the external electrodes 21, a reaction of water and aluminum (2Al+3H₂O→Al₂O₃+3H₂) and a reaction of water and zinc (Zn+H₂O→ZnO+H₂) occur, and a hydrogen gas tends to be produced. In particular, in the high temperature high humidity test, a voltage is applied to the capacitor element 20, and therefore, an oxidation reaction (Al+3H₂O→Al(OH)₃+3H⁺+3e⁻, 2Al(OH)₃→Al₂O₃+3H₂O) at an anode is promoted, and a hydrogen gas tends to be produced. Thus, it can be inferred that the hydrogen gas produced in the capacitor 10 pushes the barrier layer 3, thereby forming the swell. In the present embodiment, the amount of moisture reaching the capacitor element 20 is small, which reduces the reaction between the moisture and metal such as aluminum, thereby reducing the chance of formation of the swell by the hydrogen gas.

### (3) Variations

The first embodiment is a mere example of various embodiments of the present disclosure. The first embodiment may be modified in various manners depending on design or the like as long as the object of the present disclosure is achieved.

The above description has explained an example in which the electronic component is the capacitor, but this should not be construed as limiting. The present disclosure is applicable also when the electronic component is a passive component or active component other than the capacitor. The passive component or active component other than the capacitor respectively includes, in place of the capacitor element, a passive element or active element according to the type of the electronic component.

In the first embodiment, the laminate 35 including the clay layer 31, the water absorbing layer 32, and the base material layer 33 which are stacked one on top of another is employed, but this should not be construed as limiting. Each of the clay layer 31, the water absorbing layer 32, and the base material layer 33 may be sequentially formed in separate steps. That is, on the outer surface of the electronic component element 2 (capacitor element 20), the water absorbing layer 32 may be formed, and then, the clay layer 31 may be formed on an outer surface of the water absorbing layer 32 (on an opposite surface of the water absorbing layer 32 from the electronic component element 2), and thereafter, the base material layer 33 may be formed on an outer surface of the clay layer 31 (on an opposite surface of the clay layer 31 from the water absorbing layer 32).

An example in which the capacitor is the film capacitor has been described above, but this should not be construed as limiting. The present disclosure is also applicable to a capacitor other than the film capacitor, and, for example, the capacitor may be a solid electrolytic capacitor, and in this case, the capacitor element includes a solid electrolyte. When the laminate 35 of the present embodiment is applied to the conductive polymer solid electrolyte capacitor, the effect of protecting the polymer against oxidation is obtained. Moreover, when the laminate 35 of the present embodiment is applied to the electrolytic capacitor, the effect of preventing drying up of the electrolytic solution is obtained.

The laminate 35 of the present embodiment is applicable to organic EL device. In this case, the effect of, for example, preventing deterioration and the like of the element portion is obtained.

The laminate 35 of the present embodiment is applicable to an inductor. In this case, the effect of, for example, protecting a metal magnetic substance against oxidation is obtained.

The laminate 35 of the present embodiment is applicable to a resistor. In this case, the effect of preventing migration of silver which is accelerated due to corrosion of the thin metal film resistive element and the thin metal film and the humidity is obtained.

The laminate 35 of the present embodiment can be used as an encapsulating material (a packing material, a sealing material, and the like) for products susceptible to humidity. Examples of the products susceptible to humidity include precision machinery, construction materials, leather products, confectionery, and a hydrolysable resin (PET).

The laminate 35 of the present embodiment can be used as an encapsulating material for products which require moisture retention. Examples of the products which require moisture retention include food products and cosmetics.

### Second Embodiment

An electronic component 1 according to the present embodiment is different from the electronic component 1 according to the first embodiment in terms of the configuration of a barrier layer 3.

In the following description, components similar to those in the first embodiment are denoted by the same reference signs as those in the first embodiment, and the description thereof is accordingly omitted.

The configuration described in the second embodiment is accordingly applicable in combination with the configuration (including the variations) described in the first embodiment.

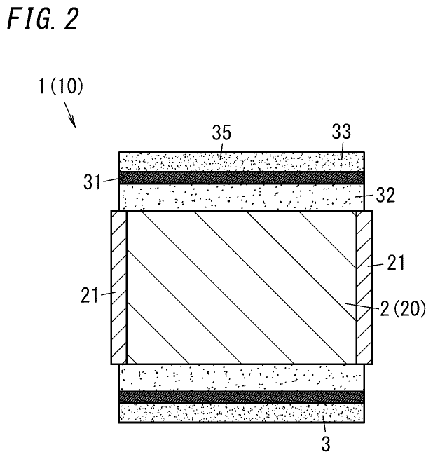

In the electronic component 1 (a capacitor 10) of the present embodiment includes the barrier layer 3 including no resin layer 34 as shown in FIG. 2. In this case, the effect of reducing, for example, moisture by the resin layer 34 cannot be obtained, but depending on an environment in which the electronic component 1 is used, such as in a place where there is little moisture, the barrier layer 3 may include only the laminate 35.

### Third Embodiment

Various types of laminates 35 having different layering structures will be described below. Each laminate 35 is applicable to the electronic component 1 of the first or second embodiment.

In the following description, components similar to those in the first or second embodiment are denoted by the same reference signs as those in the first or second embodiment, and the description thereof is accordingly omitted. The configuration described in the third embodiment is accordingly applicable in combination with the configuration (including the variations) described in the first or second embodiment.

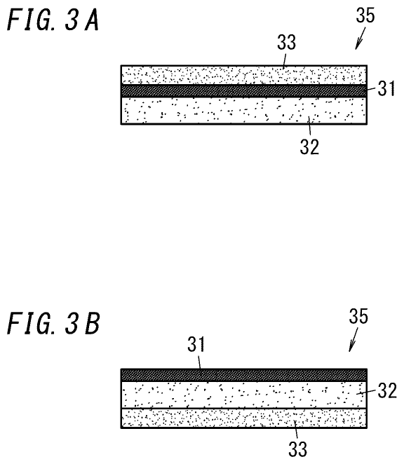

FIG. 3A is the laminate 35 shown in the first embodiment and the second embodiment. The laminate 35 includes the water absorbing layer 32, the clay layer 31, and the base material layer 33 stacked one on top of another in this order from bottom. The laminate 35 is to be disposed outside the electronic component element 2 such that a surface of the water absorbing layer 32 (an opposite surface of the water absorbing layer 32 from the clay layer 31) faces the outer surface of the electronic component element 2. Thus, one water absorbing layer 32 is disposed between the clay layer 31 and the electronic component element 2, and the clay layer 31 is located outside the water absorbing layer 32 (on an opposite side of the water absorbing layer 32 from the electronic component element 2).

A laminate 35 shown in FIG. 3B includes a base material layer 33, a water absorbing layer 32, and a clay layer 31 stacked one on top of another in this order from bottom. The laminate 35 is to be disposed outside the electronic component element 2 such that a surface of the base material layer 33 (an opposite surface of the base material layer 33 from the water absorbing layer 32) faces the outer surface of the electronic component element 2. Thus, one water absorbing layer 32 is disposed between the clay layer 31 and the electronic component element 2, and the clay layer 31 is located outside the water absorbing layer 32 (on an opposite side of the water absorbing layer 32 from the electronic component element 2). Note that when the clay layer 31 is located on an outermost side in the second embodiment including the barrier layer 3 without the resin layer 34, moisture readily passes through the clay layer 31, and therefore, the laminate 35 having the base material layer 33 outside the clay layer 31 as shown in FIG. 3A is preferably employed.

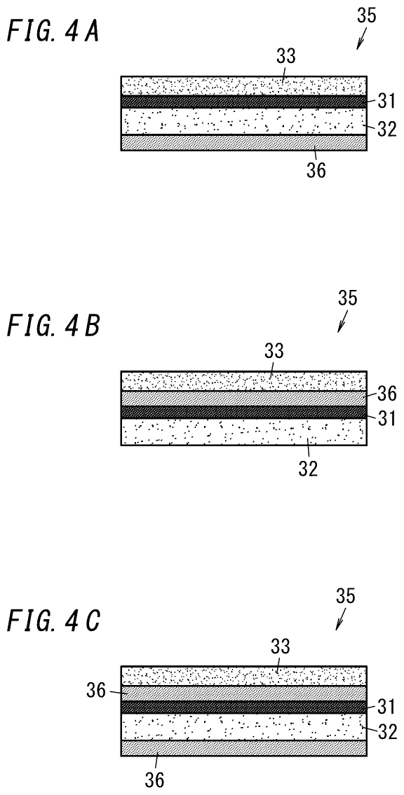

A laminate 35 shown in FIG. 4A includes an adhesion layer 36, a water absorbing layer 32, a clay layer 31, and a base material layer 33 stacked one on top of another in this order from bottom. That is, this laminate 35 corresponds to the laminate 35 of FIG. 3A further including an adhesion layer 36 disposed on a lower surface of the water absorbing layer 32. The laminate 35 is to be disposed outside the electronic component element 2 such that a surface of the adhesion layer 36 (an opposite surface of the adhesion layer 36 from the water absorbing layer 32) faces the outer surface of the electronic component element 2. Thus, one water absorbing layer 32 is disposed between the clay layer 31 and the electronic component element 2, and the clay layer 31 is located outside the water absorbing layer 32 (on an opposite side of the water absorbing layer 32 from the electronic component element 2). Moreover, the laminate 35 can be bonded to the outer surface of the electronic component element 2 via the adhesion layer 36, thereby improving the adhesion of the laminate 35 to the electronic component element 2.

The adhesion layer 36 may include a resin different from the crystalline resin included in the base material layer 33. For example, when the crystalline resin included in the base material layer 33 is crystalline polypropylene, the adhesion layer 36 includes a resin except for the crystalline polypropylene.

The adhesion layer 36 preferably has a viscosity development temperature of lower than 130° C. The viscosity development temperature is a temperature at which the adhesion layer 36 develops viscosity. That is, the adhesion layer 36 develops viscosity due to thermal fusion, wherein when the viscosity is improved more than that before the thermal fusion, a temperature at the timing of the thermal fusion is the viscosity development temperature. In order to form the adhesive layer 36 having a viscosity development temperature of lower than or equal to 130° C., the adhesive layer 36 includes a resin different from the crystalline resin included in the base material layer 33. As the resin different from the crystalline resin included in the base material layer 33, a hot melt resin is usable. The hot melt resin is a resin which is melted by heat and which reversibly hardens when the heat is removed. As the hot melt resin, a low-melting-point hot melt resin is preferable. Examples of the hot melt resin include an ethylene vinyl acetate (EVA)-based resin, an olefin-based resin, a rubber-based resin, a polyamide-based resin, a nylon-based resin, a polyurethane-based resin, and an acryl-based resin.

When the base material layer 33 is made of crystalline polypropylene, the adhesive layer 36 is preferably made of an olefin-based resin having a high affinity for the crystalline polypropylene. As the olefin-based resin having a high affinity for the crystalline polypropylene, an amorphous resin is preferably included in the adhesive layer 36. When the base material layer 33 is made of crystalline polypropylene, the adhesive layer 36 is preferably made of amorphous polypropylene having a lower crystallinity than the crystalline polypropylene. The amorphous polypropylene is, for example, polypropylene which includes no polarity group and is highly branched polypropylene or which is obtained by copolymerization of ethylene, butene, and the like. The amorphous polypropylene generally has a density of less than or equal to 0.855 g/cm³.

Moreover, the adhesive layer 36 preferably includes a resin including a polarity group. As the resin including a polarity group, modified polypropylene is usable. As the modified polypropylene, acid-modified polypropylene is usable. The acid-modified polypropylene is polypropylene modified by acid and its anhydrate, and examples of the acid include maleic acid, maleic acid anhydride, fumaric acid, citraconic acid, citraconic anhydride, mesaconic acid, crotonic acid, itaconic acid, itaconic acid anhydride, aconitic acid, and aconitic acid anhydride. As the acid-modified polypropylene, carboxylic acid anhydrate-modified polypropylene is usable, and examples of the acid-modified polypropylene include maleic acid anhydride-modified polypropylene, acrylic acid-modified polypropylene, and imine-modified polypropylene.

The thickness of the adhesive layer 36 is not particularly limited, but in consideration of performances such as bonding strength, adhesion, and ease of formation, the thickness is preferably less than or equal to 5 μm, and more preferably less than or equal to 1 μm.

A laminate 35 shown in FIG. 4B includes a water absorbing layer 32, a clay layer 31, an adhesion layer 36, and a base material layer 33 stacked one on top of another in this order from bottom. That is, this laminate 35 corresponds to the laminate 35 of FIG. 3A further including an adhesion layer 36 between the clay layer 31 and the base material layer 33. The laminate 35 is to be disposed outside the electronic component element 2 such that a surface of the water absorbing layer 32 (an opposite surface of the water absorbing layer 32 from the clay layer 31) faces the outer surface of the electronic component element 2. Thus, one water absorbing layer 32 is disposed between the clay layer 31 and the electronic component element 2, and the clay layer 31 is located outside the water absorbing layer 32 (on an opposite side of the water absorbing layer 32 from the electronic component element 2). Since the laminate 35 includes the adhesion layer 36 between the clay layer 31 and the base material layer 33, the adhesion between the clay layer 31 and the base material layer 33 can be improved.

A laminate 35 shown in FIG. 4C includes an adhesion layer 36, a water absorbing layer 32, a clay layer 31, an adhesion layer 36, and a base material layer 33 stacked one on top of another in this order from bottom. That is, this laminate 35 corresponds to the laminate 35 of FIG. 3A further including an adhesion layer 36 on a lower surface of the water absorbing layer 32 and an adhesion layer 36 between the clay layer 31 and the base material layer 33. The laminate 35 is to be disposed outside the electronic component element 2 such that a surface of the adhesion layer 36 (an opposite surface of the adhesion layer 36 from the water absorbing layer 32) faces the outer surface of the electronic component element 2. Thus, one water absorbing layer 32 is disposed between the clay layer 31 and the electronic component element 2, and the clay layer 31 is located outside the water absorbing layer 32 (on an opposite side of the water absorbing layer 32 from the electronic component element 2). Moreover, the laminate 35 can be bonded to the outer surface of the electronic component element 2 via the adhesion layer 36, thereby improving the adhesion of the laminate 35 to the electronic component element 2. Since the laminate 35 includes the adhesion layer 36 between the clay layer 31 and the base material layer 33, the adhesion between the clay layer 31 and the base material layer 33 can be improved.

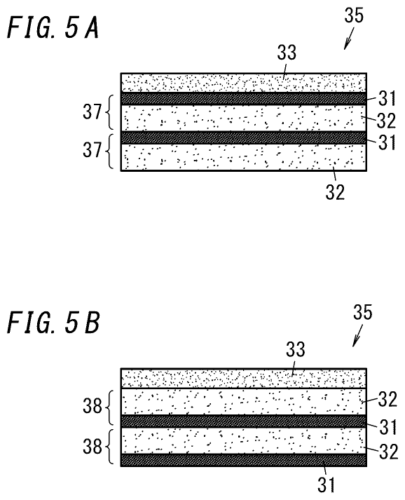

A laminate 35 shown in FIG. 5A includes a water absorbing layer 32, a clay layer 31, a water absorbing layer 32, a clay layer 31, and a base material layer 33 stacked one on top of another in this order from bottom. That is, in the laminate 35, two unit layers 37 each including the water absorbing layer 32 and the clay layer 31 are stacked under the base material layer 33. The laminate 35 is to be disposed outside the electronic component element 2 such that a surface of a lowermost one of the water absorbing layers 32 (an opposite surface of the lowermost one of the water absorbing layers 32 from the clay layer 31) faces the outer surface of the electronic component element 2. Thus, one water absorbing layer 32 is disposed between the clay layer 31 and the electronic component element 2, and the clay layer 31 is located outside the water absorbing layer 32 (on an opposite side of the water absorbing layer 32 from the electronic component element 2).

A laminate 35 shown in FIG. 5B includes a clay layer 31, a water absorbing layer 32, a clay layer 31, a water absorbing layer 32, and a base material layer 33 stacked one on top of another in this order from bottom. That is, in the laminate 35, two unit layers 38 each including the water absorbing layer 32 and the clay layer 31 are stacked under the base material layer 33. The laminate 35 is to be disposed outside the electronic component element 2 such that a surface of a lowermost one of the clay layers 31 (an opposite surface of the lowermost one of the clay layers 31 from the water absorbing layer 32) faces the outer surface of the electronic component element 2. Thus, one water absorbing layer 32 is disposed between a second lowest one of the clay layer 31 and the electronic component element 2, and the second lowest clay layer 31 is located outside the water absorbing layer 32 (on an opposite side of the water absorbing layer 32 from the electronic component element 2).

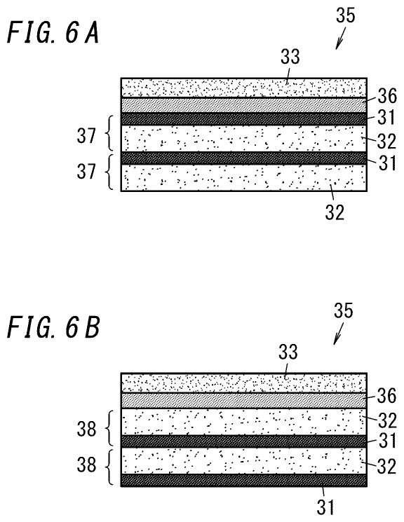

A laminate 35 shown in FIG. 6A includes a water absorbing layer 32, a clay layer 31, a water absorbing layer 32, a clay layer 31, an adhesion layer 36, and a base material layer 33 stacked one on top of another in this order from bottom. That is, this laminate 35 corresponds to the laminate 35 of FIG. 5A further including an adhesion layer 36 disposed between an upper one of the unit layers 37 and the base material layer 33. The other configurations are the same as those in FIG. 5A.

A laminate 35 shown in FIG. 6B includes a clay layer 31, a water absorbing layer 32, a clay layer 31, a water absorbing layer 32, an adhesion layer 36, and a base material layer 33 stacked one on top of another in this order from bottom. That is, this laminate 35 corresponds to the laminate 35 of FIG. 5B further including an adhesion layer 36 between an upper one of the unit layers 38 and the base material layer 33. The other configurations are the same as those in FIG. 5B.

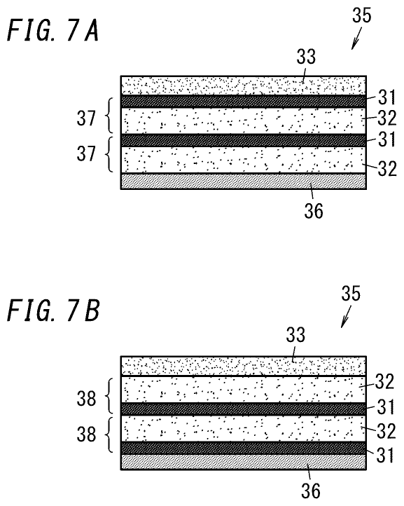

A laminate 35 shown in FIG. 7A includes an adhesion layer 36, a water absorbing layer 32, a clay layer 31, a water absorbing layer 32, a clay layer 31, and a base material layer 33 stacked one on top of another in this order from bottom. That is, this laminate 35 corresponds to the laminate 35 of FIG. 5A further including an adhesion layer 36 on a lower surface of the water absorbing layer 32 of FIG. 5A. The laminate 35 is to be disposed outside the electronic component element 2 such that a surface of the adhesion layer 36 (an opposite surface of the adhesion layer 36 from the water absorbing layer 32) faces the outer surface of the electronic component element 2. Thus, one water absorbing layer 32 is disposed between the clay layer 31 and the electronic component element 2, and the clay layer 31 is located outside the water absorbing layer 32 (on an opposite side of the water absorbing layer 32 from the electronic component element 2). Moreover, the laminate 35 can be bonded to the outer surface of the electronic component element 2 via the adhesion layer 36, thereby improving the adhesion of the laminate 35 to the electronic component element 2.

A laminate 35 shown in FIG. 7B includes an adhesion layer 36, a clay layer 31, a water absorbing layer 32, a clay layer 31, a water absorbing layer 32, and a base material layer 33 stacked one on top of another in this order from bottom. That is, this laminate 35 corresponds to the laminate 35 of FIG. 5B further including an adhesion layer 36 on a lower surface of the water absorbing layer 32. The laminate 35 is to be disposed outside the electronic component element 2 such that a surface of the adhesion layer 36 (an opposite surface of the adhesion layer 36 from the water absorbing layer 32) faces the outer surface of the electronic component element 2. Thus, one water absorbing layer 32 is disposed between the clay layer 31 and the electronic component element 2, and the clay layer 31 is located outside the water absorbing layer 32 (on an opposite side of the water absorbing layer 32 from the electronic component element 2). Moreover, the laminate 35 can be bonded to the outer surface of the electronic component element 2 via the adhesion layer 36, thereby improving the adhesive property of the laminate 35 to the electronic component element 2.

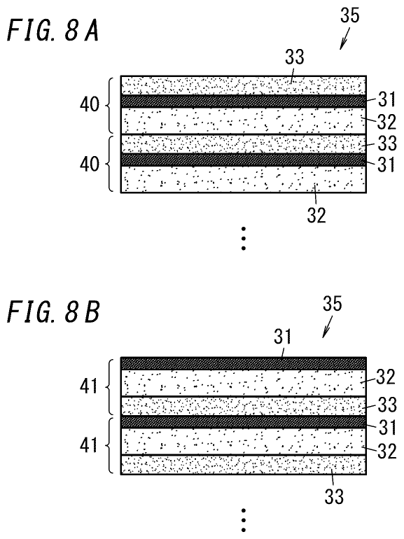

A laminate 35 shown in FIG. 8A includes a plurality of unit layers 40 stacked one on top of another. Each unit layer 40 has a configuration similar to the configuration of the laminate 35 shown in FIG. 3A.

A laminate 35 shown in FIG. 8B includes a plurality of unit layers 41 stacked one on top of another. Each unit layer 41 has a configuration similar to the configuration of the laminate 35 shown in FIG. 3B.

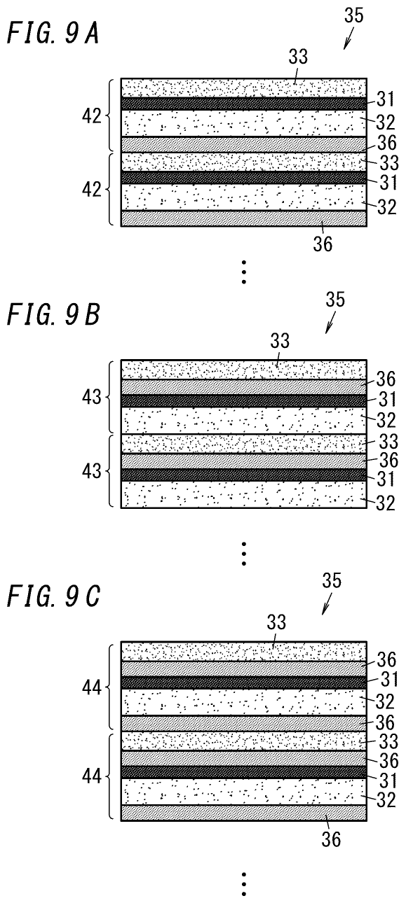

A laminate 35 shown in FIG. 9A includes a plurality of unit layers 42 stacked one on top of another. Each unit layer 42 has a configuration similar to the configuration of the laminate 35 shown in FIG. 4A.

A laminate 35 shown in FIG. 9B includes a plurality of unit layers 43 stacked one on top of another. Each unit layer 43 has a configuration similar to the configuration of the laminate 35 shown in FIG. 4B.

A laminate 35 shown in FIG. 9C includes a plurality of unit layers 44 stacked one on top of another. Each unit layer 44 has a configuration similar to the configuration of the laminate 35 shown in FIG. 4C.

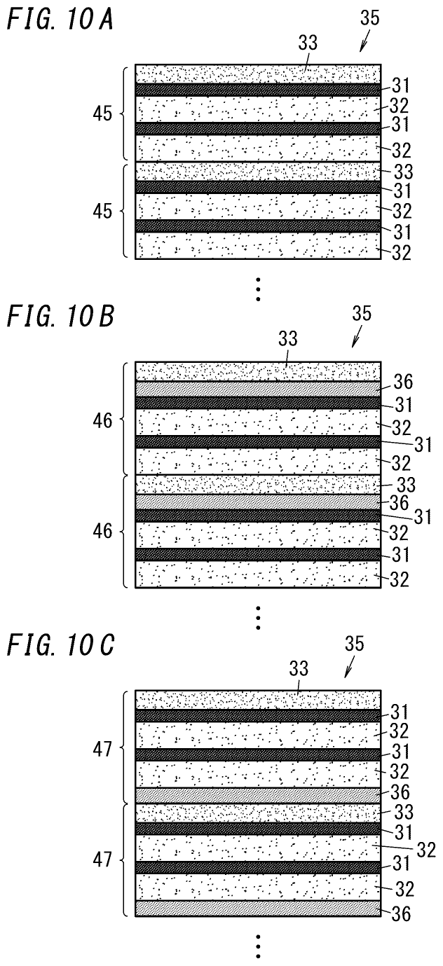

A laminate 35 shown in FIG. 10A includes a plurality of unit layers 45 stacked one on top of another. Each unit layer 45 has a configuration similar to the configuration of the laminate 35 shown in FIG. 5A.

A laminate 35 shown in FIG. 10B includes a plurality of unit layers 46 stacked one on top of another. Each unit layer 46 has a configuration similar to the configuration of the laminate 35 shown in FIG. 6A.

A laminate 35 shown in FIG. 10C includes a plurality of unit layers 47 stacked one on top of another. Each unit layer 47 has a configuration similar to the configuration of the laminate 35 shown in FIG. 7A.

In the present embodiment, at least one of the clay layer 31, the water absorbing layer 32, the base material layer 33, or the adhesion layer 36 of the laminate 35 includes a plurality of clay layers 31, a plurality of water absorbing layers 32, a plurality of base material layers 33, or a plurality of adhesion layers 36, respectively. Thus, as compared with the case where only one each of the layers is disposed, moisture passing through the laminate 35 can be reduced, and the moisture resistance of the capacitor 10 (the electronic component 1) can be improved. Moreover, the plurality of layers are stacked one on top of another, and therefore, even when a defect such as a pin hole is present in a specific layer, the other layers stacked one on top of another can cover the defect, and the moisture resistance of the capacitor 10 is less likely to be impaired.

### Fourth Embodiment

An electronic component 1 according to the present embodiment is different from the electronic component 1 according to the first and second embodiments in terms of the configuration of a barrier layer 3.

In the following description, components similar to those of the first and second embodiments are denoted by the same reference signs as those in the first and second embodiments, and the description thereof is accordingly omitted.

The configuration described in the fourth embodiment is accordingly applicable in combination with the configurations (including variations) described in the first and second embodiments.

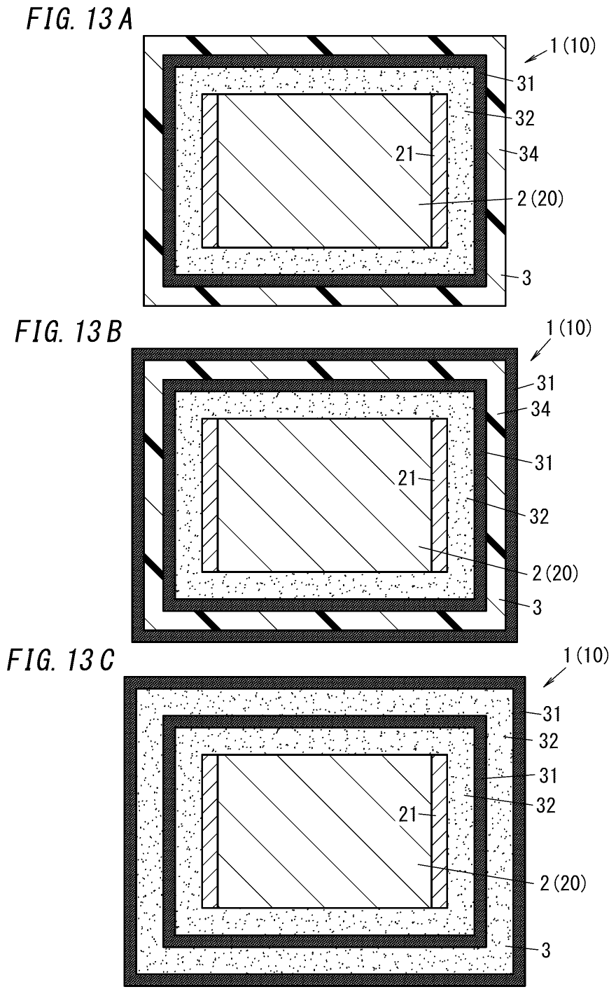

In FIG. 13A, the entirety of a capacitor element 20 (an electronic component element 2) including end surfaces of external electrodes 21 is covered with a water absorbing layer 32, a clay layer 31, and a resin layer 34, thereby forming the barrier layer 3. In this case, the end surfaces of the external electrodes 21 are also covered with the water absorbing layer 32 and the clay layer 31 as compared with the configuration of FIG. 1, thereby reducing moisture reaching the external electrodes 21, and thus, the moisture resistance of the capacitor 10 (the electronic component 1) can be improved.

In FIG. 13B, a barrier layer 3 is shown, which corresponds to the barrier layer 3 of FIG. 13A further including a clay layer 31 disposed outside the resin layer 34. In this case, the barrier layer 3 includes the plurality of clay layers 31, thereby further reducing moisture passing through the barrier layer 3, and thus, the moisture resistance of the capacitor 10 (the electronic component 1) can be improved as compared with the configuration of FIG. 13A.

In FIG. 13C, a barrier layer 3 is shown, which corresponds to the barrier layer 3 of FIG. 13B including, as a water absorbing layer 32, a resin layer 34 containing a water absorbing material. In this case, the barrier layer 3 includes a plurality of water absorbing layers 32, thereby further reducing moisture passing through the barrier layer 3, and thus, the moisture resistance of the capacitor 10 (the electronic component 1) can be improved as compared with the configuration of FIG. 13B.

### (Summary)

An electronic component 1 according to the present embodiment has the following aspects.

An electronic component (1) of a first aspect includes an electronic component element (2) and a barrier layer (3) disposed outside the electronic component element (2). The barrier layer (3) includes a clay layer (31) containing clay and a water absorbing layer (32) containing a water absorbing material. The water absorbing layer (32) is disposed between the electronic component element (2) and the clay layer (31).

This aspect has the advantage that, since the barrier layer (3) enables moisture and gas to be suppressed from externally reaching the electronic component element (2), an electronic component in which a change in performance due to moisture absorption is small and which thus has high moisture resistance can be provided. In particular, since the barrier layer (3) includes the water absorbing layer (32), moisture can be absorbed by the water absorbing layer (32), thereby highly effectively suppressing the moisture from reaching the electronic component element (2), and additionally, since the water absorbing layer (32) is disposed between the electronic component element (2) and the clay layer (31), the moisture passing through the clay layer (31) is absorbed by the water absorbing layer (32), and thus, as compared with the case without the clay layer (31), the amount of moisture reaching the water absorbing layer (32) can be reduced, and the water absorption of the water absorbing layer (32) can be suppressed from decreasing.

A second aspect is the electronic component (1) of the first aspect, wherein the clay layer (31) further contains a binder (312), and the clay contains mineral particles (311) including a plate-shaped or thin-flake-shaped particle.

This aspect has the advantage that the clay layer (31) has high moisture permeation resistance provided by the mineral particles (311) having a high aspect ratio.

A third aspect is the electronic component (1) of the first or second aspect, wherein the water absorbing layer (32) further contains a binder, and the water absorbing material includes zeolite.

This aspect has the advantage that the water absorbing layer (32) has high moisture permeation resistance provided by the zeolite which is a water absorbing material having high water absorption.

A fourth aspect is the electronic component (1) of any one of the first to third aspects, wherein a content of the water absorbing material in the water absorbing layer (32) is greater than or equal to 2.5 parts by mass with respect to 100 parts by mass of the water absorbing layer (32).

This aspect has the advantage that the water absorbing layer (32) has high moisture permeation resistance provided by a prescribed amount of the water absorbing material.

A fifth aspect is the electronic component (1) of any one of the first to fourth aspects, wherein the barrier layer (3) includes a laminate (35) including the clay layer (31) and the water absorbing layer (32).

This aspect has the advantage that the clay layer (31) and the water absorbing layer (32) can be handled as the laminate (35), and the barrier layer (3) is easily formed.

A sixth aspect is the electronic component (1) of any one of the first to fifth aspects, wherein the barrier layer (3) includes a plurality of the water absorbing layers (32), and at least one of the water absorbing layers (32) is disposed between the electronic component element (2) and the clay layer (31).

This aspect has the advantage that the plurality of water absorbing layers (32) increase the water absorption of the barrier layer (3) and can further reduce the influence of moisture over the electronic component element (2).

A capacitor (10) of a seventh aspect being the electronic component of any one of the first to sixth aspects, wherein the electronic component element (2) of the electronic component is a capacitor element (20).

This aspect has the advantage that the capacitor (10) in which a change in electrostatic capacitance due to permeation of moisture is small can be provided.

An eighth aspect is the capacitor (10) of the seventh aspect, wherein the capacitor element (20) includes a metalized film including a dielectric film and an electrode film on the dielectric film.

There is the possibility that the electrostatic capacitance of a film capacitor may decrease due to oxidation of an Al electrode during energization when the film capacitor absorbs moisture, but this aspect has the advantage that the electrostatic capacitance is less likely to decrease.

A laminate (35) of a ninth aspect includes: at least one clay layer (31) containing clay which suppresses passage of moisture; and at least one water absorbing layer (32) containing a water absorbing material such that the moisture passing through the at least one clay layer (31) is absorbed by the water absorbing material.

This aspect has the advantage that the moisture passing through the laminate (35) can be reduced by the clay layer (31) and the water absorbing layer (32). Moreover, this aspect has the advantage that after moisture passes through the clay layer (31), the moisture is absorbed by the water absorbing layer (32), and therefore, as compared with the case without the clay layer (31), the amount of moisture reaching the water absorbing layer (32) can be reduced, and the water absorption of the water absorbing layer (32) can be suppressed from decreasing.

A tenth aspect is the laminate (35) of the ninth aspect, wherein the laminate (35) further includes a base material layer (33).

This aspect has the advantage that the base material layer (33) holding the clay layer (31) and the water absorbing layer (32) can be handled, and thus the handleability is excellent.

An eleventh aspect is the laminate (35) of the ninth or tenth aspect, wherein the laminate (35) further includes an adhesion layer (36).

This aspect has the advantages that the clay layer (31) and the water absorbing layer (32) can be bonded to each other via the adhesion layer (36), the laminate (35) can be bonded to another member via the adhesion layer (36), stacking the clay layer (31) and the water absorbing layer (32) one on top of another can be facilitated, or bonding of the laminate (35) to another member can be facilitated.

A twelfth aspect is the laminate (35) of any one of the ninth to eleventh aspects, comprising a plurality of at least one of the clay layer (31) and the water absorption layer (32).

This aspect has the advantage that moisture passing through the laminate (35) can be reduced as compared with the case where one each of the clay layer (31) and the water absorbing layer (32) is provided.

### REFERENCE SIGNS LIST

1 Electronic Component
10 Capacitor
2 Electronic Component Element
20 Capacitor Element
3 Barrier Layer
31 Clay Layer
311 Mineral Particle
312 Binder

1. An electronic component comprising:
an electronic component element; and
a barrier layer disposed outside the electronic component element,
the barrier layer including
a clay layer containing clay and
a water absorbing layer containing a water absorbing material,
the water absorbing layer being disposed between the electronic component element and the clay layer.

2. The electronic component of claim 1, wherein
the clay layer further contains a binder, and
the clay contains mineral particles including a plate-shaped or thin-flake-shaped particle.

3. The electronic component of claim 1, wherein
the water absorbing layer further contains a binder, and
the water absorbing material includes zeolite.

4. The electronic component of claim 1, wherein
a content of the water absorbing material in the water absorbing layer is greater than or equal to 2.5 parts by mass with respect to 100 parts by mass of the water absorbing layer.

5. The electronic component of claim 1, wherein
the barrier layer includes a laminate including the clay layer and the water absorbing layer.

6. The electronic component of claim 1, wherein
the barrier layer includes a plurality of the water absorbing layers, and
at least one of the water absorbing layers being disposed between the electronic component element and the clay layer.

7. A capacitor being the electronic component of claim 1, wherein
the electronic component element of the electronic component is a capacitor element.

8. The capacitor of claim 7, wherein
the capacitor element includes a metalized film including a dielectric film and an electrode film on the dielectric film.

9. A laminate comprising:
at least one clay layer containing clay which suppresses passage of moisture; and
at least one water absorbing layer containing a water absorbing material such that the moisture passing through the at least one clay layer is absorbed by the water absorbing material.

10. The laminate of claim 9, further comprising a base material layer.

11. The laminate of claim 9, further comprising an adhesion layer.

12. The laminate of claim 9, comprising a plurality of at least one of the clay layer and the water absorption layer.

13. The electronic component of claim 2, wherein
the water absorbing layer further contains a binder, and
the water absorbing material includes zeolite.

14. The electronic component of claim 2, wherein
a content of the water absorbing material in the water absorbing layer is greater than or equal to 2.5 parts by mass with respect to 100 parts by mass of the water absorbing layer.

15. The electronic component of claim 2, wherein
the barrier layer includes a laminate including the clay layer and the water absorbing layer.

16. The electronic component of claim 2, wherein
the barrier layer includes a plurality of the water absorbing layers, and
at least one of the water absorbing layers being disposed between the electronic component element and the clay layer.

17. A capacitor being the electronic component of claim 2, wherein
the electronic component element of the electronic component is a capacitor element.

18. The capacitor of claim 17, wherein
the capacitor element includes a metalized film including a dielectric film and an electrode film on the dielectric film.
